(19) United States
(12) Patent Application Publication
(10) Pub. No.: US 2002/0160246 A1
(43) Pub. Date: Oct. 31, 2002

(54) Enthalpy recovery system and method

(75) Inventor: Michael M. Walsh, Fairfield, CT (US)

Correspondence Address: Joe Hulett, Wong Cabello, Suite 600, 20333 SH 249, Houston, TX, 77070, US

(73) Assignee: Plug Power Inc., Latham, NY

(21) Appl. No.: 10/132,929

(22) Filed: Apr. 26, 2002

Related U.S. Application Data
(60) Provisional application No. 60/287,208, filed on Apr. 27, 2001.

(51) Int. Cl. H01M 8/04

(52) U.S. Cl. 429/26; 429/13; 429/22; 165/281; 165/177

(57) ABSTRACT

A system and method for enthalpy transfer in a fuel cell includes flowing a gas and liquid water through a thermally conductive conduit, flowing a relatively hot gas containing water vapor across an external portion of the conduit, and transferring enough heat from the hot gas to cool the hot gas below its dew point and to cause a portion of the liquid water in the conduit to evaporate.

### CROSS REFERENCE TO RELATED APPLICATIONS

This application claims priority under 35 USC 119(e) from U.S. Provisional Application No. 60/287,208, filed Apr. 27, 2001, naming Walsh as inventor, and titled “ENTHALPY RECOVERY SYSTEM AND METHOD.” That application is incorporated herein by reference in its entirety and for all purposes.

### BACKGROUND

The invention generally relates to an enthalpy recovery system and method for an integrated fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and

O₂+4H⁺+4e⁻→2H₂O at the cathode of the cell.

A typical fuel cell has a terminal voltage of up to one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLS) may be located on each side of each PEM to act as a gas diffusion media and in some cases to provide a support for the fuel cell catalysts. In this manner, reactant gases from each side of the PEM may pass along the flow channels and diffuse through the GDLs to reach the PEM. The PEM and its adjacent pair are often assembled together in an arrangement called a membrane electrode assembly (MEA).

A fuel cell system may include a fuel processor that converts a hydrocarbon (natural gas or propane, as examples) into a fuel flow for the fuel cell stack. Exemplary fuel processor systems are described in U.S. Pat. Nos. 6,207,122, 6,190,623, 6,132,689, which are hereby incorporated by reference. In general, fuel cell power output is increased by raising fuel and air flow to the fuel cell in proportion to the stoichiometric ratios dictated by the equations listed above. Thus, a controller of the fuel cell system may monitor the output power of the stack and based on the monitored output power, estimate the fuel and air flows required to satisfy the power demand. In this manner, the controller regulates the fuel processor to produce this flow, and in response to controller detecting a change in the output power, the controller estimates a new rate of fuel flow and controls the fuel processor accordingly.

The ratio of fuel or air provided to a fuel cell over what is theoretically required by a given power demand is sometimes referred to as “stoich”. For example, 1 anode stoich refers to 100% of the hydrogen theoretically required to meet a given power demand, while 1.2 stoich refers to 20% excess hydrogen over what is theoretically required. Since in real conditions it is typical that not all of the hydrogen or air supplied to a fuel cell will actually react, it may be desirable to supply excess fuel and air to meet a given power demand.

The fuel cell system may provide power to a load, such as a load that is formed from residential appliances and electrical devices that may be selectively turned on and off to vary the power that is demanded by the load. Thus, in some applications the load may not be constant, but rather the power that is consumed by the load may vary over time and change abruptly. For example, if the fuel cell system provides power to a house, different appliances/electrical devices of the house may be turned on and off at different times to cause the load to vary in a stepwise fashion over time.

Referring to FIG. 1, a prior art integrated fuel cell system 100 is shown. Natural gas is injected into the system through conduit 102. The natural gas flows through desulfurization vessel 104, which contains a sulfur-adsorbent material such as activated carbon. The de-sulfurized natural gas is then flowed to a conversion reactor 110 via conduit 105. Before being reacted in the conversion reactor 110, the de-sulfurized natural gas is mixed with air 106 and steam 108. It will be appreciated that the conversion reactor 110 is an autothermal reactor, which reacts the hydrocarbon with the oxygen and steam to produce a hydrogen-rich reformate that includes carbon monoxide. The converted natural gas, referred to as reformate, then flows through a series of high temperature shift reactors 112 and 114, utilizing the shift reaction to react carbon monoxide in the reformate with steam to produce additional hydrogen and reduce the carbon monoxide present. A low temperature shift reactor 116 can also be used to further reduce CO levels. Finally, a preferential oxidation (PROX) reactor 118 can be used to oxidize the residual carbon monoxide in the reformate. Such reactors for fuel cell systems are well known.

Also as known in the art, such reactor configurations may vary. For example, some systems may not include the PROX reactor 118, or may have only a single high temperature shift reactor, etc. It will be appreciated that the primary function of this series of reactors is to maximize hydrogen production while minimizing carbon monoxide levels in the reformate. The reformate is then flowed via conduit 120 to the anode chambers (not shown) of a fuel cell stack 122.

Air enters the system via conduit 124, and as previously mentioned through conduit 106. In the present example, the fuel cell stack 122 uses sulfonated flourocarbon polymer PEMs that need to be kept moist during operation to avoid damage. While the reformate 120 tends to be saturated with water, the ambient air 124 tends to be subsaturated. To prevent the ambient air 124 from drying out the fuel cells in stack 122, the air 124 is humidified bypassing it through an enthalpy wheel 126, which also serves to preheat the air 124. The theory and operation of enthalpy wheels are described in U.S. Pat. No. 6,013,385, which is hereby incorporated by reference. The air 124 passes through the enthalpy wheel 126 through the cathode chambers (not shown) of the fuel cell stack 122. The air 124 picks up heat and moisture in the stack 122, and is exhausted via conduit 128 back through the enthalpy wheel 126. The enthalpy wheel 126 rotates with respect to the injection points of these flows such that moisture and heat from the cathode exhaust 128 is continually passed to the cathode inlet air 124 prior to that stream entering the fuel cell.

The anode exhaust from the fuel cell is flowed via conduit 130 to an oxidizer 132, sometimes referred to as an “anode tailgas oxidizer”. The cathode exhaust leaves the enthalpy wheel 126 via conduit 134 and is also fed to the oxidizer 132 to provide oxygen to promote the oxidation of residual hydrogen and hydrocarbons in the anode exhaust 130. As examples, the oxidizer 132 can be a burner or a catalytic burner (similar to automotive catalytic converters). The exhaust of the oxidizer is vented to ambient via conduit 136. The heat generated in the oxidizer 132 is used to convert a water stream 138 into steam 108 that is used in the system.

Referring to FIG. 2, a schematic diagram is shown illustrating a prior art enthalpy transfer device. An enthalpy wheel system 200 includes a housing 202 having a first inlet 204 and a first outlet 206, and a second inlet 210 and a second outlet 208. A cylindrical, porous zeolite core 218 is mounted on an internal shaft 216 that extends to a shaft 214 outside the housing 202 connecting to a motor 212. During operation, the motor 212 turns the cylindrical core 218 via shaft 214, 216.

The housing assembly 202 generally includes rotary seal orifices (not shown) in association with each inlet and outlet such that flows sent through the core 218 are not bypassed around the core 218 within the housing 202 to one of the other inlets or outlets. The core 218 generally contains honeycomb tubes with porous walls running parallel to the rotational axis of the core 218 such that gas tends to flow through the core 218 with minimal diffusion in other directions. The core material is generally hydrophilic, such that it tends to adsorb mist and water vapor from saturated streams passing through it, and likewise tends to impart water vapor into sub-saturated streams passing through it.

As an example, during operation, cathode exhaust from a fuel cell may be injected into first inlet 204. The cathode exhaust is hot relative to ambient air, and is generally saturated with water vapor. Dry ambient air is flowed through inlet 210. Since the core 218 is continually rotating, the water imparted to a section of the core by the cathode exhaust will be picked up by the dry air flow as the wet portion of the core 218 rotates through the zone in which the dry air is flowed. Likewise, a portion of the core 218 that has been dried and cooled by the ambient air will be heated and wetted as that section is rotated through the zone in which the cathode exhaust is flowed. As an example, the core may be turned at approximately 33 revolutions per minute during this process.

There is a continuing need for integrated fuel cell systems designed to achieve objectives including the forgoing in a robust, cost-effective manner.

### SUMMARY

In general, the invention provides methods and associated enthalpy transfer systems for transferring enthalpy from one stream in a fuel cell system to another stream. An advantage of the invention is that it provides a means of transferring enthalpy and water vapor between streams in a cost effective manner with a minimum of moving parts. Also, as discussed herein, the use of particular materials in certain embodiments can provide cost and weight reductions over traditional heat transfer approaches. Such weight reductions in thermally active fuel cell system components can also shorten the time required to start up such systems. In an aspect of certain embodiments, the invention also provides a method of effecting isothermal transfer of latent heat through a heat transfer surface of a fuel cell system. As another advantage, the invention provides a means of conserving system water usage by enabling recovery of water vapor from fuel cell system exhaust streams.

As an example, one such system includes a conduit having an internal surface and an external surface, wherein the conduit has a gas inlet, a gas outlet, and a water injection port. The conduit is adapted to receive a flow of liquid water into the water injection port, and the conduit is adapted to receive a flow of a first fluid through the gas inlet.

A pump is provided that is in fluid communication with the water injection port and a water reservoir. The pump has an electrical connection to a controller, such that the pump can be modulated to vary a flow of water from the water reservoir to the water injection port according to a control signal from the controller.

A housing encloses a portion of the conduit, wherein the housing includes a first inlet and a first outlet, wherein the housing is adapted to circulate a second fluid through the first inlet across a portion of the external surface of the conduit and out the first outlet, and wherein the housing further includes a drain in fluid communication with the water reservoir.

Various embodiments of the invention can include the following features, alone or in combination. The conduit can be a convoluted metal tube. The conduit can be stainless steel with a thickness of less than 0.01 inches (e.g., 0.005 inches). It will be appreciated that such thicknesses are substantially less than those of materials traditionally used in heat transfer devices such as shell and tube heat exchangers and plate heat exchangers. The conduit can be a helical coil. For example, the conduit can be a helical coil with a vertical orientation such that water injected into a top portion of the coil will flow by gravity to a bottom portion of the coil.

In some embodiments, the aforementioned housing can comprise a shell portion of a shell and tube heat exchanger, where the conduit comprises a tube portion of the shell and tube heat exchanger. The external surface of the conduit can comprise a plurality of heat transfer fins. The housing can comprise a first channel of a plate heat exchanger, and the conduit can comprise a second channel of a plate heat exchanger, where the first channel and second channel are adapted to flow heat through a common surface. It will be appreciated that the heat exchanger configuration may be selected to accommodate various design concerns. For example, a plate heat exchanger may be selected with relatively narrow channels to maximize the amount of heat transfer surface that a given flow is exposed to. Similarly, the flow rates and size of the heat exchanger may be selected to accommodate various applications.

The first fluid can be air, and the gas outlet can be in fluid communication with a cathode chamber of a fuel cell. The first fluid can comprise air and methane, wherein the gas outlet is in fluid communication with a fuel processing reactor inlet. The second fluid can be reformate. The system can further comprise a fuel cell having an anode exhaust stream in fluid communication with an oxidizer, wherein the second fluid is an exhaust stream from the oxidizer.

In another aspect, the invention provides a method of enthalpy transfer within a fuel cell system, comprising the following steps: flowing a first gas through an inside of a thermally conductive conduit; flowing liquid water through the inside of the conduit; flowing a second gas across an external surface of the conduit, wherein the second gas contains water vapor and has a temperature greater than a temperature of the first gas; and transferring heat from the second gas through the conduit to the liquid water, such that the temperature of the second gas falls below a dew point temperature of the second gas, and such that a portion of the liquid water in the conduit evaporates.

Various embodiments may also include any of the following steps or features, alone or in combination. The conduit can be a convoluted metal tube (e.g., stainless steel with a thickness of less than 0.01 inches). The conduit can be a vertically oriented helical coil. The liquid water can be flowed through the inside of the conduit through a water injection port along a top portion of the conduit. Such methods can further comprise: gravity-draining the liquid water to a bottom portion of the conduit; and operating a pump to flow the water from the bottom portion to the water injection pump. The pump can comprise an electrical connection to a controller, and such method can further comprise varying the flow of water by modulating a control signal from the controller to the pump.

The first fluid can be air, and the gas outlet can be in fluid communication with a cathode chamber of a fuel cell. The first fluid can comprise air and methane, and the gas outlet can be in fluid communication with a fuel processing reactor inlet. The second fluid can be reformate. The second fluid can be an exhaust stream from an oxidizer adapted to receive an anode exhaust stream from a fuel cell.

In another aspect, embodiments can include a method of enthalpy transfer within a fuel cell system, comprising the following steps: flowing methane from a first source through an inside of a thermally conductive conduit; flowing oxygen from a second source through the inside of the conductive conduit; flowing liquid water from a third source through the inside of the conduit; flowing a gas across an external surface of the conduit, wherein the gas contains water vapor and has a temperature greater than a temperature of a mixture of methane and oxygen in the conduit; and transferring heat from the gas through the conduit to the liquid water, such that the temperature of the gas falls below a dew point temperature of the gas, and such that a portion of the liquid water in the conduit evaporates. Embodiments can also include varying the liquid water flow to maintain a molar ratio of water to methane greater than 2.0, as well as any of the aforementioned steps and features, either alone or in combination.

Advantages and other features of the invention will become apparent from the following description, drawing and claims.

### DESCRIPTION OF THE DRAWINGS

FIG. 1 is a schematic diagram illustrating a prior art fuel cell system.

FIG. 2 is a schematic diagram illustrating a prior art enthalpy transfer device.

FIG. 3 is a perspective view of an enthalpy transfer conduit.

FIG. 4 is a magnified view of a portion of the enthalpy transfer conduit shown in FIG. 3.

FIG. 5 is a schematic diagram of an enthalpy transfer system.

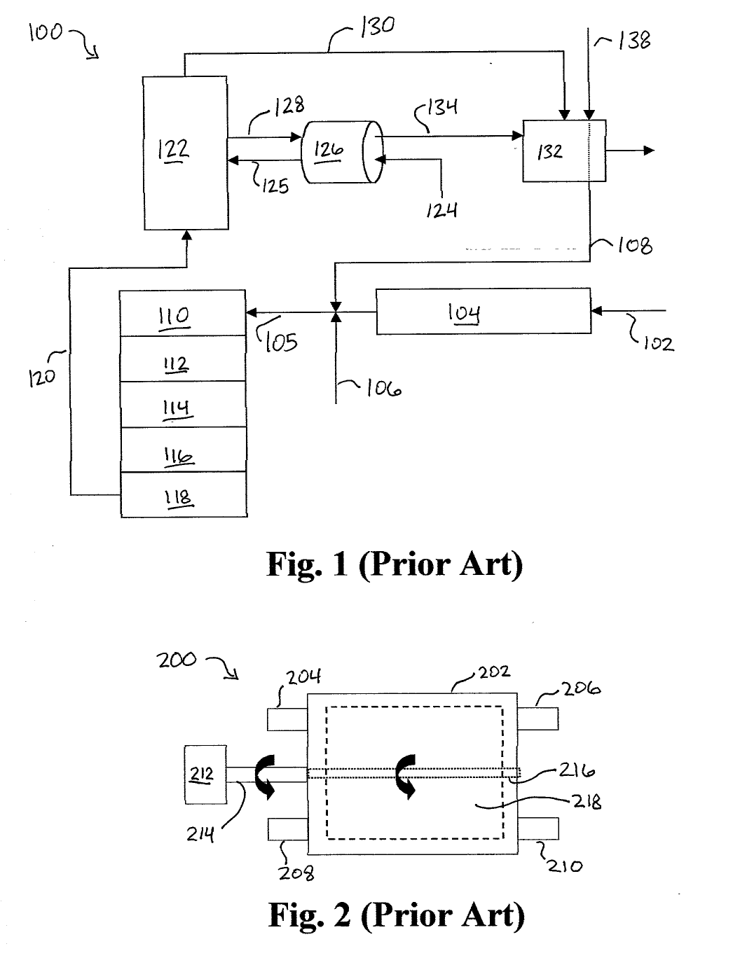

### DETAILED DESCRIPTION

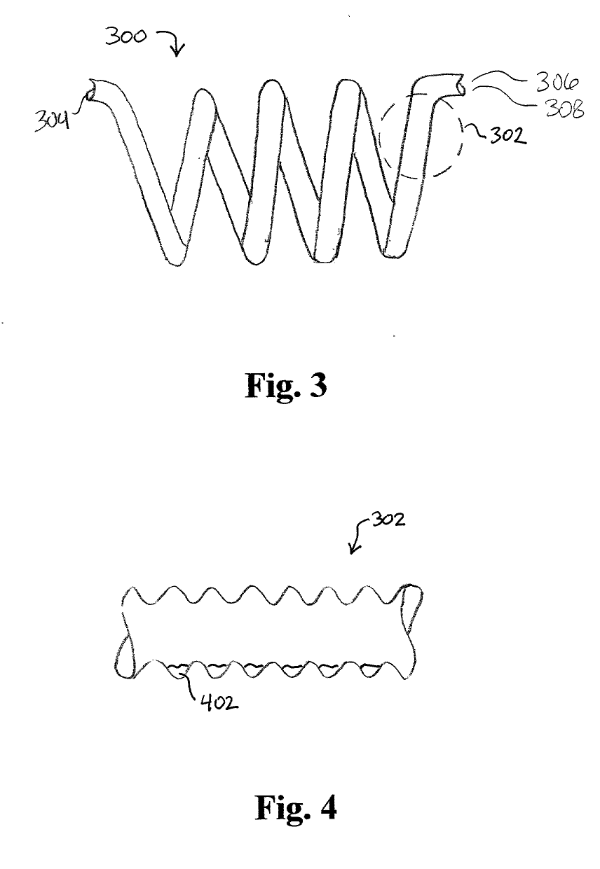

Referring to FIG. 3, a perspective view is shown of an enthalpy transfer conduit 300 in the form of a helical coil. As previously mentioned, the conduit is thermally conductive, and can be made of a convoluted stainless steel tubing material. For example, a suitable annularly corrugated stainless steel hose is available from Witzenmann GmbH, Metallschlauch-Fabrik Pforzhein, Ostliche Karl-Friedrich-Strasse 134 D-75175 Pforzheim. In the context of this invention, the terms corrugated and convoluted are used interchangeably. An advantage of such materials is that they are generally much thinner than many traditional heat transfer tube materials. For example, suitable corrugated stainless steel hoses can have a thickness of 0.01 inches or less. Non corrugated tubing may be generally thicker.

In a system, the coil shown in FIG. 3 would preferably be oriented in a vertical position such that a gas could be flowed through inlet 304, preferably at the bottom of the coil, up through outlet 306. Liquid water is injected into a water injection port 308 and allowed to gravity-flow down through gas inlet 304. Thus, in such embodiments, the gas and water are in a counter-flow relationship. In other embodiments, the gas and liquid can also be co-flowed (e.g., both flowed down through the coil). Other embodiments are possible.

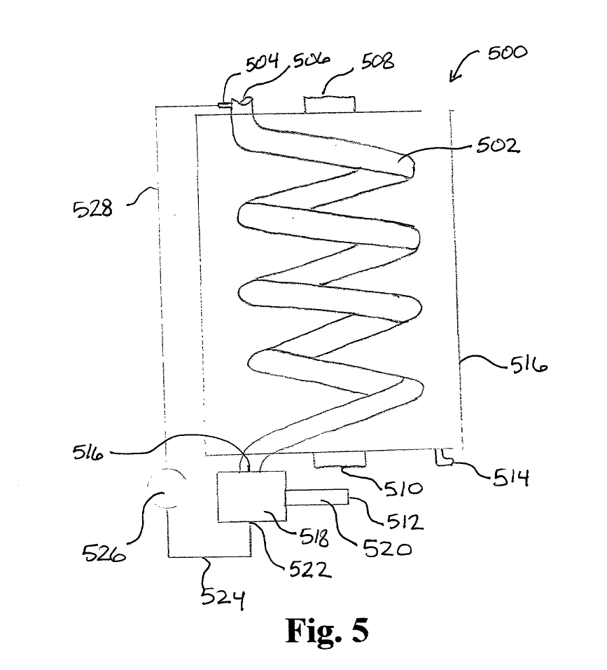

For illustration purposes, FIG. 4 shows a magnified view of a portion 302 of the enthalpy transfer conduit shown in FIG. 3. As the water flows down through the coil, a portion of the water collects in the annular corrugations 402 and cascades in this manner through the tube.

Referring to FIG. 5, a schematic diagram is shown of an enthalpy transfer system 500 utilizing the convoluted tube material shown in FIGS. 3 and 4. The convoluted tube 502 is positioned in a vertical helix and has an inlet 506 and an outlet 516. The convoluted tube conduit has an internal surface and an external surface. Gas that is unsaturated with water vapor (generally referred to as dry gas or unsaturated gas) is flowed through inlet 506, exits the outlet 516, and flows through reservoir/drain 518 to gas outlet conduit 520. In some embodiments, this gas can be air. For example, such a flow of air may comprise the air flow to the cathode chamber of a fuel cell (e.g., a PEM fuel cell requiring humidified reactants). In other embodiments, the gas flowed through conduit 502 can be a feed stream to a fuel processing reactor. For example, as known in the art, it may be desirable to maintain a particular “steam to carbon” ratio (e.g., molar ratio of water to methane) in the inlet to the fuel processor greater than 2.0 to prevent the accumulation of carbon deposits in the fuel processor.

Water is injected into the tube 502 at injection port 504. The water flows by gravity down through the tube 502, filling the bottom portion of the convolutions 402 (See FIG. 4) as it flows from one convolution to another. The water is collected in drain/reservoir 518 and is drained through drain orifice 522 to conduit 524. A pump 526 pumps the water through conduit 528 to injection port 504. The pump can be connected to a controller (not shown) that can be adapted to vary the flow of water through the conduit 502 (e.g., according to a look-up table with respect to system operating point or a water level or humidity measurement, as examples).

The system also includes a housing 516 that has an inlet 510 and an outlet 508. A second gas is flowed into inlet 510, flows across an external portion of the conduit 502, and exits the housing 516 through exit 508. As examples, the second gas can be a reformate stream in a fuel cell system. Reformate streams in PEM fuel cell systems are generally flowed from a fuel processing reactor saturated with water at temperatures higher than the operating temperature of the fuel cell (e.g., 100-200° C.). Systems under the present invention can be used to cool the reformate to the operating temperature of the fuel cell (e.g., 60-80° C.).

Similarly, as previously discussed, some fuel cells systems include an oxidizer to remove residual hydrogen or carbon monoxide from the exhaust of the fuel cell. Systems under the present invention can be used to cool the exhaust from such an oxidizer and recover a portion of the water produced by the combustion occurring in the oxidizer.

In some embodiments, the housing can also include baffles (not shown) to direct the flow and control residence time of the second gas in the housing. The second gas contains water vapor and has a temperature higher than the temperature of the gas flowed through the conduit 502. The conduit 502 is thermally conductive, such that heat is transferred from the flow of the second gas to the conduit 502. This heat in turn flows into the water flowing through conduit 502, and causes a portion of the water to evaporate into the gas in the conduit 502.

As heat transfer through the conduit 502 continues, the temperature of the second gas eventually falls below its dew point, at which point water in the second gas begins to condense. In this context, the dew point refers to the temperature at which the gas has a relative humidity of 100%. The condensing water flows by gravity to the bottom of the housing and is flowed through drain orifice 514.

It will be appreciated that sensible heat is transferred from the second stream as its temperature falls toward its dew point, and during the condensation of water from the second gas, latent heat is also transferred. In this context, the latent heat refers to the energy differential between the liquid phase and the vapor phase. Ordinarily, evaporation of liquids (e.g., as occurring in the conduit 502) is associated with cooling. This occurs because the liquid must absorb enough heat to enter the gas phase. The cooling occurs because such heat is carried off into the gas phase by the liquid. The amount of heat required to transfer the liquid to the gas phase is referred to as the latent heat of the liquid.

These dynamics also occur in the present system 500, as water is evaporated as it flows through conduit 502. However, in the present system, an equilibrium is reached between the amount of heat carried into the gas phase in the conduit 502, and the amount of heat added to the system via the second gas flowing through inlet 510 into the housing 516 and exiting through outlet 508. As previously mentioned, the second gas contains water vapor and has a temperature higher than the temperature of the gas flowed through the conduit 502.

As the evaporation of water in conduit 502 removes heat from the conduit 502, the conduit 502 tends to cool the second gas toward its dew point. When the temperature of the second gas reaches its dew point, water vapor in the second gas starts to condense. This condensation releases the latent heat (i.e., phase change energy) of the condensing water into the conduit 502, where it enters the liquid water on the inside of the conduit and is carried away from the conduit as the water evaporates. Thus at equilibrium, the amount of heat removed from the second gas flow in theory equals the amount of added to the liquid water evaporated inside the conduit 502.

Since the dry gas inside the conduit 502 receives both sensible and latent heat from the second gas, it is considered that enthalpy is transferred from the second gas to the dry gas. In this context, enthalpy refers to the transfer of both sensible and latent heat. In some embodiments, this direct isothermal transfer of latent heat is a key feature and advantage, since in the prior art, efficient heat transfer typically requires large temperature differentials. Also, in some embodiments, the orifice 514 feeds the condensate from the second gas to the dry gas, such that effectively, enthalpy and water vapor are both transferred from the second gas to the dry gas.

Embodiments of the present invention can be tailored for specific operating conditions, such as the temperature and flow rates of the gasses inside and outside the conduit 502. For example, an objective of some embodiments may include recovering a sufficient amount of water from the second gas outside the conduit 502, such that the system as a whole is water independent (e.g., the system does not need an external flow of water to humidify reactant streams). To accomplish this purpose, the amount of surface area of the conduit 502 can be increased as needed. The water and gas flow through the inside of the conduit can also be increased to remove greater amounts of heat from the second gas, thereby resulting in greater amounts of condensation being captured from the second gas. Similarly, as previously mentioned, the housing can also include baffles to direct the flow of the second gas in order to provide greater residence time or contact in the housing with the conduit 502.

While the foregoing discussion has focused on embodiments of the present invention utilizing corrugated tubing as a heat transfer surface, other embodiments are possible that utilize other heat transfer configurations. For example, in some embodiments, the housing associated with the system can be a shell portion of a shell and tube heat exchanger, and the conduit (e.g., conduit 502 of FIG. 5) can be represented by the tube portion of the shell and tube heat exchanger.

In other embodiments, the tubing (e.g., conduit 502 of FIG. 5) can include external fins to increase the heat transfer surface area contacted by the second gas flowing through the housing across the external surface of the conduit.

In still other embodiments, a plate heat exchanger configuration can be utilized. For example, the housing of the system discussed with respect to FIG. 5 can be represented by a first channel of a plate heat exchanger, wherein the conduit comprises a second channel of the plate heat exchanger. In such an arrangement, the first channel and second channel are positioned to allow heat flow through a common surface.

The operation of a system similar to the system 500 described with respect to FIG. 5 can also be expressed under the present invention as a method of enthalpy transfer within a fuel cell system. For example, one embodiment includes the following steps:

flowing a first gas through an inside of a thermally conductive conduit;

flowing liquid water through the inside of the conduit;

flowing a second gas across an external surface of the conduit, wherein the second gas contains water vapor and has a temperature greater than a temperature of the first gas; and

transferring heat from the second gas through the conduit to the liquid water, such that the temperature of the second gas falls below a dew point temperature of the second gas, and such that a portion of the liquid water in the conduit evaporates.

Similarly, another embodiment includes the following slightly different steps:

flowing methane from a first source through an inside of a thermally conductive conduit;

flowing oxygen from a second source through the inside of the conductive conduit;

flowing liquid water from a third source through the inside of the conduit;

flowing a gas across an external surface of the conduit, wherein the gas contains water vapor and has a temperature greater than a temperature of a mixture of methane and oxygen in the conduit; and

transferring heat from the gas through the conduit to the liquid water, such that the temperature of the gas falls below a dew point temperature of the gas, and such that a portion of the liquid water in the conduit evaporates.

Other embodiments are possible.

Such methods may further include any of the features described above. For example, an additional step may include gravity-draining the liquid water to a bottom portion of the conduit, and operating a pump to flow the water from the bottom portion to the water injection pump. In some embodiments, the pump can be operated according to a control signal from a controller, and such methods can further include the step of varying the flow of water by modulating a control signal from the controller to the pump.

While the invention has been disclosed with respect to a limited number of embodiments, those skilled in the art, having the benefit of this disclosure, will appreciate numerous modifications and variations therefrom. It is intended that the invention covers all such modifications and variations as fall within the true spirit and scope of the invention.

What is claimed is:

1. An enthalpy transfer system, comprising:
a conduit having an internal surface and an external surface, wherein the conduit has a gas inlet, a gas outlet, and a water injection port, wherein the conduit is adapted to receive a flow of liquid water into the water injection port, wherein the conduit is adapted to receive a flow of a first fluid through the gas inlet;
a pump in fluid communication with the water injection port and a water reservoir, the pump having an electrical connection to a controller, wherein the pump is adapted to vary a flow of water from the water reservoir to the water injection port according to a control signal from the controller; and
a housing enclosing a portion of the conduit, wherein the housing includes a first inlet and a first outlet, wherein the housing is adapted to circulate a second fluid through the first inlet across a portion of the external surface of the conduit and out the first outlet, wherein the housing further includes a drain in fluid communication with the water reservoir.

2. The system of claim 1, wherein the conduit is a convoluted metal tube.

3. The system of claim 2, wherein the conduit is stainless steel with a thickness of less than 0.01 inches.

4. The system of claim 1, wherein the conduit is a helical coil.

5. The system of claim 1, wherein the housing comprises a shell portion of a shell and tube heat exchanger, and wherein the conduit comprises a tube portion of the shell and tube heat exchanger.

6. The system of claim 1, wherein the external surface of the conduit comprises a plurality of heat transfer fins.

7. The system of claim 1, wherein the housing comprises a first channel of a plate heat exchanger, and wherein the conduit comprises a second channel of a plate heat exchanger, wherein the first channel and second channel are adapted to flow heat through a common surface.

8. The system of claim 1, wherein the first fluid is air, and wherein the gas outlet is in fluid communication with a cathode chamber of a fuel cell.

9. The system of claim 1, wherein the first fluid comprises air and methane, and wherein the gas outlet is in fluid communication with a fuel processing reactor inlet.

10. The system of claim 1, wherein the second fluid is reformate.

11. The system of claim 1, further comprising a fuel cell having an anode exhaust stream in fluid communication with an oxidizer, wherein the second fluid is an exhaust stream from the oxidizer.

12. A method of enthalpy transfer within a fuel cell system, comprising:
flowing a first gas through an inside of a thermally conductive conduit;
flowing liquid water through the inside of the conduit;
flowing a second gas across an external surface of the conduit, wherein the second gas contains water vapor and has a temperature greater than a temperature of the first gas; and
transferring heat from the second gas through the conduit to the liquid water, such that the temperature of the second gas falls below a dew point temperature of the second gas, and such that a portion of the liquid water in the conduit evaporates.

13. The method of claim 12, wherein the conduit is a convoluted metal tube.

14. The method of claim 13, wherein the conduit is stainless steel with a thickness of less than 0.01 inches.

15. The method of claim 12, wherein the conduit is a vertically oriented helical coil.

16. The method of claim 15, wherein the liquid water is flowed the inside of the conduit through a water injection port along a top portion of the conduit, further comprising:
gravity-draining the liquid water to a bottom portion of the conduit; and
operating a pump to flow the water from the bottom portion to the water injection pump.

17. The method of claim 16, wherein the pump comprises an electrical connection to a controller, and further comprising:
varying the flow of water by modulating a control signal from the controller to the pump.

18. The method of claim 12, wherein the first fluid is air, and wherein the gas outlet is in fluid communication with a cathode chamber of a fuel cell.

19. The method of claim 12, wherein the first fluid comprises air and methane, and wherein the gas outlet is in fluid communication with a fuel processing reactor inlet.

20. The method of claim 12, wherein the second fluid is reformate.

21. The method of claim 12, wherein the second fluid is an exhaust stream from an oxidizer adapted to receive an anode exhaust stream from a fuel cell.

22. A method of enthalpy transfer within a fuel cell system, comprising:
flowing methane from a first source through an inside of a thermally conductive conduit;
flowing oxygen from a second source through the inside of the conductive conduit;
flowing liquid water from a third source through the inside of the conduit;
flowing a gas across an external surface of the conduit, wherein the gas contains water vapor and has a temperature greater than a temperature of a mixture of methane and oxygen in the conduit; and
transferring heat from the gas through the conduit to the liquid water, such that the temperature of the gas falls below a dew point temperature of the gas, and such that a portion of the liquid water in the conduit evaporates.

23. The method of claim 22, further comprising:
varying the liquid water flow to maintain a molar ratio of water to methane greater than 2.0.
